(19) United States
(12) Patent Application Publication
(10) Pub. No.: US 2022/0033235 A1
(43) Pub. Date: Feb. 3, 2022

(54) A TUGBOAT HYDRAULIC GENSET

(71) Applicant: SVITZER A/S, København K (DK)

(72) Inventor: Thomas BANGSLUND, Ølstykke (DK)

(21) Appl. No.: 17/276,427

(22) PCT Filed: Sep. 17, 2019
(86) PCT No.: PCT/EP2019/074873

§ 371 Date: Mar. 15, 2021

(30) Foreign Application Priority Data
Sep. 18, 2018 (DK) PA201870606

(51) Int. Cl. B66D 1/08; B63B 21/16; B63B 35/68; B63J 3/04; A01K 73/06

(52) U.S. Cl. CPC B66D 1/08; B63B 21/16; B63H 2021/202; B63J 3/04; A01K 73/06; B63B 35/68

(57) ABSTRACT

A sea vessel (1), such as a tugboat or a fishing vessel, including a hydraulic winch (10) connected to a hydraulic system (100), and at least one main engine with a main engine crankshaft (22) connected to a propeller or a thruster. The hydraulic system (100) comprising: a first, hydraulically powered genset (106) including a hydraulic motor and a generator, at least one hydraulic pump (105) connected to said crankshaft (22). The hydraulic pump (105) is configured for driving said first genset (106) to generate electricity, and the hydraulic pump (105) is configured for driving said hydraulic winch (10), and first valve element (102) are used for selectively directing hydraulic fluid to the hydraulic winch (10) or to said first genset (106) of said hydraulic system.

### SUMMARY

The invention relates to a sea vessel, such as a tugboat or a fishing vessel, including a hydraulic winch connected to a hydraulic system, and at least one main engine with a main engine crankshaft connected to a propeller or a thruster.

It is currently known to use a tugboat comprising a main engine and at least one auxiliary generator or a tugboat having multiple auxiliary generators arranged on the tugboat, where at least one of the auxiliary generators is a diesel generator. The hydraulic winch system includes a hydraulic pump for driving a generator to generate electricity. The hydraulic pump is part of the winch delivery on a tugboat.

The existing winch hydraulic system has a pump, which operates at a power of approximately 150 KW. One of the disadvantages of the winch hydraulic system is that this rating is such that most of the time not all power is required for operating the hydraulic winch. When the hydraulic winch is not in use, the hydraulic system is idling.

The general object of the present invention is to provide a sea vessel with a hydraulic system, where the running hours of the auxiliary generator(s) can be reduced.

A further object of the present invention is to use the winch hydraulics to drive a genset to reduce the running hours on the remaining diesel genset and to reduce maintenance of the hydraulic system.

The above need and object together with numerous other needs and objects will be evident from below detailed description. According to a first aspect of the present invention said need and object can be obtained by a sea vessel, such as a tugboat or a fishing vessel, including:

a hydraulic winch connected to a hydraulic system, and at least one main engine with a main engine crankshaft connected to a propeller or a thruster, said hydraulic system comprising:
a first, hydraulically powered genset including a hydraulic motor and a generator,
at least one hydraulic pump connected to said crankshaft,
said hydraulic pump being configured for driving said first genset to generate electricity, and
said hydraulic pump being configured for driving said hydraulic winch; and
a first valve element for selectively directing hydraulic fluid to said hydraulic winch or to said first genset of said hydraulic system.

The invention brings about the possibility to remove one of the diesel driven generator sets of the prior art sea vessels and replace a diesel driven generator set with a generator driven by the hydraulic pump of the hydraulic system, hereby achieving a hydraulic system where the hydraulic pump can be used for other purposes, when the hydraulic pump is not used for driving the hydraulic winch of the sea vessel.

By replacing one of the diesel driven generator sets, it is possible to utilize the winch hydraulic system to take off power from the main engine crankshaft to produce electricity by using the hydraulic motor to drive the generator of the first hydraulic genset.

The hydraulic pump can according to the present invention be used in two situations on the sea vessel, the first situation being the primary purpose, where the hydraulic pump is used for delivering hydraulic fluid to the hydraulic winch arranged on the sea vessel and the second situation being the secondary purpose, where the hydraulic pump is used for delivering hydraulic fluid to the hydraulic motor of the first, hydraulically powered genset.

The first, hydraulically powered genset includes a hydraulic motor and a generator. The hydraulic pump will be configured for driving the hydraulic genset to generate electricity. One or more first valve elements can be used for selectively directing hydraulic fluid either to the hydraulic winch located on the sea vessel or to said first genset of said hydraulic system arranged on the sea vessel. By removing one or more of the auxiliary generators, the size and the weight of the sea vessel can be changed. This invention offers a cost effective way of establishing a shaft generator on a tugboat or fishing vessel. The generator of the first hydraulically powered genset may be a shaft generator.

Hydraulic fluid from the winch hydraulic pumps is diverted to a hydraulic motor that in turn spins the generator of the first, hydraulically powered genset. The advantage is that the hydraulic system is over specified. This means that adding a hydraulic genset to the hydraulic system does not affect the performance of the hydraulic system. The hydraulic pumps are normally rotating at all times but then the swash plate regulation is at 0 stroke when no hydraulic fluid is needed from the winch. There could be scenarios where the genset and the hydraulic winch is running at the same time however there would be a limit to the max output from the genset in such conditions.

The hydraulic genset can provide 70-90 kW of power (electricity), preferably about 80 kW. This may replaces one of the existing auxiliary genset. The hydraulic genset can power the hotel load of the tugboat. It will be connected to an energy management system. The hydraulic genset can also charge batteries of the sea vessel as required.

The term “genset” should in this context refer to a motor connected to a generator. The genset can be used to generate electricity to a sea vessel. The size of the genset would in the present invention generate electrical power up to 100 kW.

The term “main engine” is used to define the engine located beneath the deck of the sea vessel and the main engine typically produce 750 to 3000 horsepower (500 to 20 000 kW) and usually have an extreme power:tonnage-ratio (normal cargo- and passenger ships have a P:T-ratio, kW:GRT, of 0.35-1.20, whereas large tugs typically are 2.20-4.50 and small harbour-tugs 4.0-9.5). The engines are often the same as those used in railroad engines, but typically drive the propeller mechanically instead of converting the engine output to power electric motors, as is common for railroad engines.

The terms “tugboat” or “tug” are in the context of this application used to define a vessel used to manoeuvre, primarily by towing or pushing, other vessels (see shipping) in harbours, over the open sea or through rivers and canals. Furthermore, tugboats can be used to tow barges, disabled ships, or other equipment like towboats.

The term “sea vessel” should in the context of this application also cover any water vessels to be operated on a river or a lake.

In a further embodiment, the sea vessel further comprises a second genset, such as a diesel genset, including a diesel motor and a generator, for delivering electricity to the sea vessel. Through the use of a second genset, it is possible to provide electrical power to the electrical component of the sea vessel and hereby obtain a back solution in the even that there is a need for additional power generation.

In a further embodiment, the first genset is configured for generating power up to 100 kW. Through the use of a first genset, it is possible to provide a hydraulic genset, which is able to power the hotel load of the tugboat. The hydraulic genset will be connected to an energy management system and the hydraulic genset can also bed used for charging one or more batteries on the sea vessel if it is required.

In a further embodiment, the first genset is the only genset on the sea vessel. Through the use of only one first genset, it is possible for the first genset to deliver all the electrical power needed during operation of the sea vessel such as a tugboat. As only one genset is to be arranged on the sea vessel it is furthermore possible to reduce the size of the fuel system and the number of exhaust pipe. If one or more of the auxiliary generators are removed, then the size and the weight of the vessel can be reduced.

In a further embodiment, the hydraulic system comprises a number of fluid connecting pipes connected to said hydraulic pump, one pipe being connected to a hydraulic winch located near the bow of said vessel. Through the use of a number of fluid connections, it is possible to arrange the hydraulic component of the sea vessel in the hull of the sea vessel and to interconnect the different hydraulic components of the hydraulic system.

In a further embodiment, the hydraulic winch operates an anchor or a tug line. Through the use of a hydraulic winch it is possible to operate an anchor or a tug line. The hydraulic winch could include braking means for restraining the drum of the winch.

In a further embodiment, additional hydraulic motors are included, wherein the hydraulic pump is disconnectable from said hydraulic winch and connectable to one or more of the additional hydraulic motors, such as by further valve element. Through the use of an additional hydraulic mechanism it is possible to operate the additional equipment as anything that moves can be controlled by hydraulics in theory.

In an embodiment according to a second aspect of the present invention, a method of operating the sea vessel is disclosed, including the steps of:
changing the position of said first valve element between a first operation mode and a second operation mode,
wherein said first operation mode includes directing said hydraulic fluid from the hydraulic pump to said hydraulic winch; and
wherein said second operation mode includes directing said hydraulic fluid from the hydraulic pump to said first genset.

In a further embodiment according to a second aspect of the present invention, the method includes the step of:
directing said hydraulic fluid to said one or more additional hydraulic motors after operation of said hydraulic winch is halted.

In an embodiment according to a third aspect of the present invention, a sea vessel hydraulic system, connectable to a hydraulic winch of a sea vessel, such as a tugboat or a fishing vessel is disclosed, where the sea vessel comprises at least one main engine with a main engine crankshaft connected to a propeller or a thruster,
said hydraulic system comprising:
   a first, hydraulically powered genset for generating electricity and connectable to an electrical power distributor, such as an energy management system or a battery, of the sea vessel
   said first genset including a hydraulic motor and a generator,
   at least one hydraulic pump connectable to said crankshaft,
   a hydraulic fluid piping connecting said hydraulic pump (with said first genset,
   said hydraulic pump being connectable to said hydraulic winch for driving the hydraulic winch; and
   One or more first valve element(s) for selectively directing hydraulic fluid from said hydraulic pump to said hydraulic winch for said driving of the hydraulic winch or to said first genset(of said hydraulic system.

Hydraulic fluid from the winch hydraulic pump is diverted to a hydraulic motor that in turn spins the generator. This means that adding hydraulic genset to the hydraulic system does not affect the performance of the hydraulic system.

### DETAILED DESCRIPTION

The above and other features and advantages of the present invention will become readily apparent to those skilled in the art by the following detailed description of exemplary embodiments thereof with reference to the attached drawings, in which:

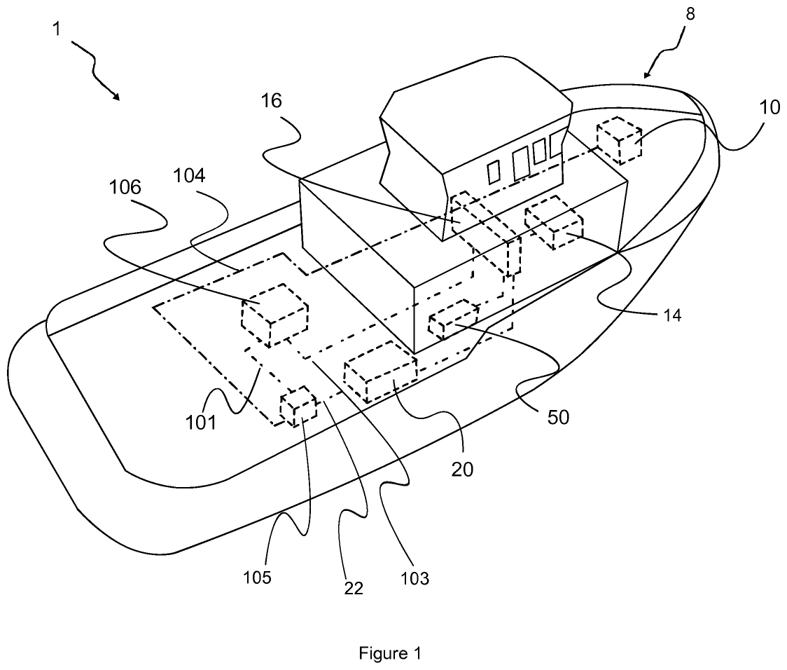

FIG. 1 shows a schematic drawing of a sea vessel according to the present invention.

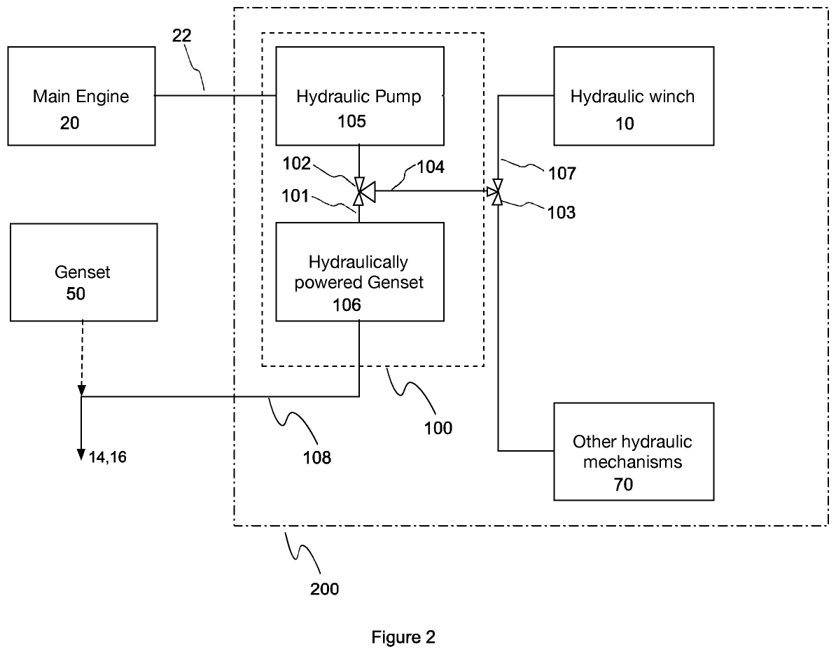

FIG. 2 shows a partial view of the hydraulic system of the sea vessel.

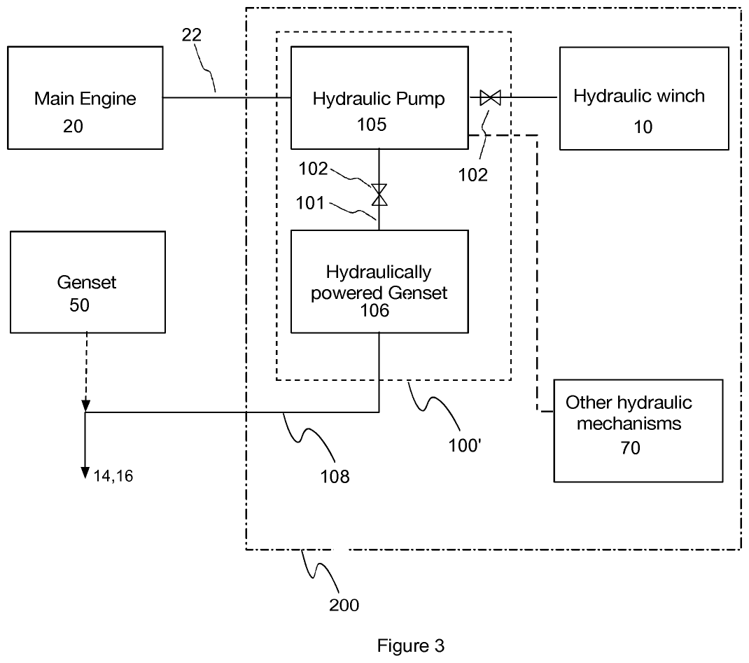

FIG. 3 shows a partial view of the hydraulic system of the sea vessel.

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments.

An aspect or an advantage described in conjunction with a particular embodiment is not necessarily limited to that embodiment and can be practiced in any other embodiments even if not so illustrated, or if not so explicitly described. Throughout, the same reference numerals are used for identical or corresponding parts.

FIG. 1 shows a schematic drawing of a sea vessel of the invention, more specifically a tugboat 1. The tugboat 1 includes a hydraulic winch 10 connected to a hydraulic system 100 (shown in FIG. 2), and one main engine 20 with a main engine crankshaft 22 connected to a propeller or a thruster (not shown in the figure). The sea vessel includes a first genset 106 and second genset 50, such as a diesel genset, including a diesel motor and a generator, for delivering electricity to the sea vessel. The hydraulic winch 10 located on the deck of the sea vessel may be used for operating an anchor or a tug line.

A tugboat will typically have a main winch on the foredeck (bow) and a secondary winch on the aft deck to enable to carry out its main tasks efficiently: braking or steering the tugboat. The towing winches are adapted to pull between 1 to 300 tonnes. The main winch on the foredeck and a towing winch on the aft deck would be a hydraulic winch having a single drum or two drums dependent the towing requirement.

Referring now to FIG. 1 and FIG. 2, the hydraulic system 100 comprises a number of fluid connecting pipes 101, 103, 104, 107. One fluid connecting pipe 104 is connected to said hydraulic pump 105, one pipe 107 being connected with to a hydraulic winch 10 located near the bow 8 of said vessel 1.

The first genset 106 is in the shown embodiment configured for generating power up to 100 kW and in the shown embodiment of the invention, the first genset 106 is the only hydraulic genset on the sea vessel. The hydraulic genset can provide 80 kW of power (electricity). This replaces one of the existing auxiliary genset. The hydraulic genset will power the hotel load of the tugboat. It will be connected to an energy management system 16 of the sea vessel. The hydraulic genset can also charge batteries of the sea vessel as required.

Referring now to FIG. 2, a view of the first hydraulic winch system is shown, where the hydraulic system 100 comprises a first genset, such as a hydraulically powered genset 106, including a hydraulic motor and a generator. A hydraulic pump 105 is connected to the crankshaft 22 and the hydraulic pump 105 is configured for driving said first genset 106 to generate electricity to power the sea vessel with electricity. Furthermore, the hydraulic pump 105 is configured for driving said hydraulic winch 10 located on the sea vessel, preferably on the deck of the sea vessel as shown in FIG. 1.

Hydraulic fluid from the winch hydraulic pumps are diverted to a hydraulic motor of the hydraulic genset to turn the generator of the hydraulic genset. The advantage is that the hydraulic system typically is dimensioned due to safe requirements specified by official authority. This means that adding a hydraulic genset to the hydraulic system does not affect the performance of the hydraulic system.

A first valve element 102 is used for selectively directing the hydraulic fluid to the hydraulic winch 10 or to the first genset 106 of said hydraulic system. The first valve element 102 is depicted as a three-way valve being operable either remotely by an energy management system 16 of the sea vessel or by an operator. The hydraulic genset can also charge batteries of the sea vessel as required. The hydraulic pump 105 is connectable to one or more of additional hydraulic motors 70, such as by further valve element(s) 108.

A second valve element 108 is used for selectively directing the hydraulic fluid to the other hydraulic mechanisms 70 of the hydraulic system. The second valve element 108 is depicted as a three-way valve.

The operator of the sea vessel is able to switch from operating the hydraulic winch 10 to operating the hydraulic powered genset 106. The first step involves changing the position of the first valve element 102 between a first operation mode and a second operation mode. The first operation mode includes directing the hydraulic fluid from the hydraulic pump 105 to said hydraulic winch 10 and the second operation mode includes directing the hydraulic fluid from the hydraulic pump 105 to the first genset 106.

It is possible for the operator of the sea vessel to direct the hydraulic fluid to said one or more additional hydraulic motors 70 after operation of the hydraulic winch 10 is halted.

Referring now to FIG. 3, a view of the hydraulic winch system 100′ is shown similar to the hydraulic winch system 100 shown in FIG. 2. The hydraulic system 100′ comprises a first genset 106, such as a hydraulically powered genset 106, including a hydraulic motor and a generator. A hydraulic pump 105 is connected to the crankshaft 22 and the hydraulic pump 105 is configured for driving the first genset 106 to generate electricity to power the sea vessel with electricity.

A first valve element 102 is used for selectively directing the hydraulic fluid to the hydraulic winch 10 and another first valve element 102 is used for selectively directing the hydraulic fluid to the first genset 106 of said hydraulic system 100′. Each of the first valve elements 102 is depicted as a two-way valve being operable either remotely by an energy management system 16 of the sea vessel or manually by an operator. The hydraulic pump 105 may be connectable to one or more of additional hydraulic motors 70 by using the further valve element(s) (not shown).

What is claimed is:

1. A sea vessel comprising:
a hydraulic winch connected to a hydraulic system, and
at least one main engine with a main engine crankshaft connected to a propeller or a thruster, said hydraulic system comprising:
a first, hydraulically powered genset including a hydraulic motor and a generator;
at least one hydraulic pump connected to said crankshaft,
said hydraulic pump being configured for driving said first genset to generate electricity; and
said hydraulic pump being configured for driving said hydraulic winch; and
a first valve element for selectively directing hydraulic fluid to said hydraulic winch or to said first genset of said hydraulic system.

2. A sea vessel according to claim 1, the sea vessel further comprising a second genset including a diesel motor and a generator, for delivering electricity to the sea vessel.

3. A sea vessel according to claim 2, wherein the first genset is configured for generating power up to 100 kW.

4. A sea vessel according to claim 1, wherein the first genset is the only genset on the sea vessel.

5. A sea vessel according to claim 1, wherein the hydraulic system comprises a number of fluid connecting pipes connected to said hydraulic pump, one pipe being connected to a hydraulic winch located near the bow of said sea vessel.

6. A sea vessel according to claim 1, wherein the hydraulic winch operates an anchor or a tug line.

7. A sea vessel according to claim 1, including additional hydraulic motors, wherein the hydraulic pump is disconnectable from said hydraulic winch and connectable to one or more of said additional hydraulic motors, such as by further valve element(s).

8. A method of operating the sea vessel according to claim 1, comprising:
changing the position of said first valve element(s) between a first operation mode and a second operation mode,
wherein said first operation mode includes directing said hydraulic fluid from the hydraulic pump to said hydraulic winch; and
wherein said second operation mode includes directing said hydraulic fluid from the hydraulic pump to said first genset.

9. A method of operating the vessel according to claim 6, comprising:
directing said hydraulic fluid to said one or more additional hydraulic motors after operation of said hydraulic winch is halted.

10. A sea vessel hydraulic system connectable to a hydraulic winch of a sea vessel, where the sea vessel comprises at least one main engine with a main engine crankshaft connected to a propeller or a thruster, said hydraulic system comprising:
a first, hydraulically powered genset for generating electricity and connectable to an electrical power distributor of the sea vessel;
said first genset including a hydraulic motor and a generator,
at least one hydraulic pump connectable to said crankshaft;
a hydraulic fluid piping connecting said hydraulic pump with said first genset;
said hydraulic pump being connectable to said hydraulic winch for driving the hydraulic winch; and
one or more first valve element(s) for selectively directing hydraulic fluid from said hydraulic pump to said hydraulic winch for said driving of the winch or to said first genset of said hydraulic system.
